(19) United States
(12) Patent Application Publication
(10) Pub. No.: US 2023/0076203 A1
(43) Pub. Date: Mar. 9, 2023

(54) DEVICE FOR THE DELIVERY OF A LIQUID PHARMACEUTICAL AND/OR NUTRACEUTICAL GELATIN SPECIALITY TO PERSONS HAVING DIFFICULTY IN SWALLOWING

(71) Applicant: PAEDIATIS, La Rochelle (FR)

(72) Inventor: Nicolas Micheaud, La Rochelle (FR)

(21) Appl. No.: 17/760,158

(22) PCT Filed: Jan. 28, 2021
(86) PCT No.: PCT/FR2021/050151

§ 371 Date: Aug. 4, 2022

(30) Foreign Application Priority Data
Feb. 4, 2020 (FR) FR2001099

(51) Int. Cl. A61J 1/06

(52) U.S. Cl. CPC A61J 1/067; A61J 2205/30

(57) ABSTRACT

A device for delivering a liquid specialty of the pharmaceutical or food supplement type comprises a gelatin reservoir and a cap hermetically closing the reservoir. The device further comprises a tab arranged on the opposite side of the cap with respect to the reservoir, the tab being filled with gelatin.

### CROSS-REFERENCE TO RELATED APPLICATIONS

This application is a national phase entry under 35 U.S.C. § 371 of International Patent Application PCT/FR2021/050151, filed Jan. 28, 2021, designating the United States of America and published as International Patent Publication WO 2021/156557 A1 on Aug. 12, 2021, which claims the benefit under Article 8 of the Patent Cooperation Treaty to French Patent Application Serial No. FR2001099, filed Feb. 4, 2020.

### TECHNICAL FIELD

The present disclosure relates to a device for the delivery of a liquid specialty, of the pharmaceutical type and/or of the food supplement type, in gelatin form manufactured on an encapsulating machine of the soft capsule type. By way of particular, but non-limiting application, this disclosure relates to a facilitated adaptation of drugs dedicated to adults for the benefit of children through a measured delivery of the content of the capsules. It can also more broadly apply to people who have difficulty swallowing.

### BACKGROUND

In Europe, more than 50% of drugs prescribed for children and adolescents are not subject to evaluation and administration authorization specific to these age groups. However, more than 20% of Europeans in 2010 are children, representing more than 100 million people.

The oral intake of drugs in the form of tablets in the solid state is often difficult for children and for the elderly, the tablets or capsules often being too large. In addition, the doses to be prescribed are not uniform, and the current tablets do not allow personalized adaptation of the doses.

The liquid forms of the drugs allow improved palatability and personalized doses, according to the age and the weight of the patients.

From an industrial point of view, when a tablet-type drug is developed, simply making a tablet smaller is not suitable for pediatric application. Obtaining an MA (Marketing Authorization) for a pediatric liquid form requires at least an additional galenic development. This additional cost tends to slow down the development of pediatric specialties.

Thus, a large number of adult specialties are given to children owing to an extemporaneous preparation called off-label. The off-label pediatric extemporaneous preparation generally consists in transforming an adult form such as a tablet, capsule or even injectable into liquid oral preparations.

Liquid forms such as syrup and suspension have the disadvantage of not being kept once they are opened for first use. The use of unidose softgel for a single dosage makes it possible to use only one part of the box of a drug without degrading the other part. The savings, particularly in the hospital environment, are significant. The use of a pipette can cause choking if the liquid is sent to the back of an infant's throat. To avoid this risk, it is particularly recommended to exert slow and gradual pressure and to place the end of the syringe or pipette inside the child's cheek to avoid the risk of suffocation, which few parents do.

Various proposals have already been made to produce preparations for children; until now, they have consisted in facilitating extemporaneous preparations. As examples, mention may be made of patent documents FR 1233412, FR 1486502, FR 1508658, FR 2190094, FR 2238644, FR 2427960 and FR 2628075.

In traditional extemporaneous preparations, there is a risk of contamination for sterile products, risk of loss of some of the components and risk of error in the quantity administered. In general, difficulties are encountered in implementing or utilizing the method to be followed in order to produce the mixture correctly. Furthermore, the stability of the mixture obtained never exceeds several days.

A traditional soft gelatin capsule or capsule of the twist-off type is unsuitable for pediatric use. The object can be easily swallowed and may cause choking.

The present disclosure aims to remedy all of the drawbacks set out above. Its objective is therefore to provide a device for distributing medicinal products or food supplements or the like, in the form of a packaging that best satisfies the following requirements:
no extemporaneous mixing;
secure dose withdrawal, and dosing accuracy;
limitation of galenic development;
packaging limitations; and
limitation of liquid flow and risk of choking or suffocation.

The device must remain simple and economical, allowing easy industrial manufacture and integration into a supply chain.

### BRIEF SUMMARY

According to a first aspect of the disclosure, proposed is a device for the delivery of a liquid specialty, for example, of the pharmaceutical or food supplement type, comprising a reservoir made of soft gelatin and a cap hermetically closing the reservoir. According to the first aspect of the disclosure, the device further comprises a tab arranged on the opposite side of the reservoir relative to the cap, the tab being filled with soft gelatin. The cap is advantageously tearable or detachable from the reservoir.

According to a preferred embodiment, the reservoir comprises a part of substantially cylindrical shape closed on the tab side, and closing on the side of the weakening line by a part of substantially conical shape.

Advantageously, the delivery device can be molded from the same material, i.e., soft gelatin.

Since gelatin is biodegradable, the device can simply dissolve in water after use and makes it possible to limit the use of plastic, aluminum or glass, unlike current systems comprising glass bottles, pipettes, single-dose PET or sachets.

The delivery device can advantageously be molded in one piece.

Preferably, the cap can be filled with soft gelatin.

Advantageously, the reservoir may have a weakening line connecting it to the cap. The weakening line makes it easier to separate the cap from the rest of the device.

The tab may have variable information, for example, information on the volume of liquid in the reservoir or the name of products contained in the reservoir.

This tab will have a cross-section equal to or less than the diameter of the reservoir part. This allows it to pass the various drying and calibration stages during its industrialization. The manufactured device can thus rotate around itself during tunnel drying and can pass the calibration step without the transverse dimension of the tab being automatically interpreted as a non-conformity.

According to a second aspect of the disclosure, proposed is a method for the delivery of a liquid specialty by means of a delivery device according to the first aspect of the disclosure, or one or more of its improvements.

The method may comprise a step in which the delivery device is held by a user by way of the tab of the device. According to one possibility, the method may comprise a step of delivering, to a child, a medication dedicated to adults that is contained in the reservoir of the device.

### BRIEF DESCRIPTION OF THE DRAWINGS

Other advantages and particularities of the disclosure will become apparent on reading the detailed description of implementations and embodiments, which are in no way limiting, with reference to the appended drawings, in which:

FIG. 1 is a top view of one embodiment of a device for the delivery of a liquid specialty,

FIG. 2 is a side view of the device shown in FIG. 1,

FIG. 3 is a rear view of the device shown in FIG. 1,

FIG. 4 is a front view of the device shown in FIG. 1,

FIG. 5 is a perspective view of a second embodiment of a device for the delivery of a liquid specialty.

### DETAILED DESCRIPTION

Since the embodiments described hereinafter are not limiting in nature, it is possible in particular to consider variants of the disclosure that comprise only a selection of the features that are described, provided that this selection of features is sufficient to confer a technical advantage or to differentiate the disclosure from the prior art. This selection comprises at least one preferably functional feature without structural details, or with only a portion of the structural details if this part alone is sufficient to confer a technical advantage or to differentiate the disclosure from the prior art.

In the remainder of the description, elements having an identical structure or similar functions will be designated by the same references.

According to the present disclosure, the necessary dose of active ingredient is contained in the reservoir of the entire capsule. The soft gelatin capsule is, in this case, used as a single-dose system. It dispenses with the use of a syringe or pipette.

There are capsules that have a protrusion forming a cap, to be cut with a scissors-type implement. The use of scissors is prohibited in the hospital, as the opening could lead to contamination of the product.

Uni-doses in a similar form can be found in ophthalmology.

There are also unscrewing caps, generally used in cosmetics. Opening is a critical step. Indeed, opening of the capsule requires holding both the body of the capsule and the opening system. In doing so, the practitioner exerts pressure on the part containing the product, which thus comes out immediately. This has at least three drawbacks:
the practitioner is in contact with the liquid, causing a risk of contamination or a risk for the practitioner;
a volume of product is lost, not only by pressure from the practitioner on the reservoir, which causes the liquid to flow, but also by the cap, which also contains liquid that is necessarily lost;
the volume of product lost results in an inaccuracy of the dose actually ingested by the patient.

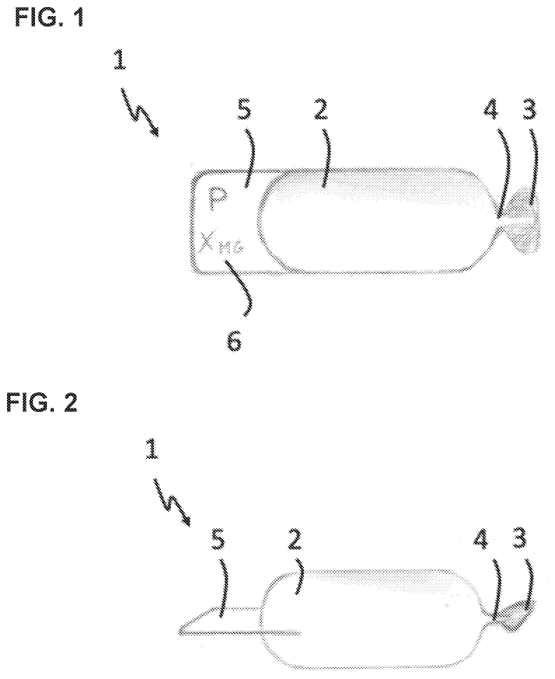

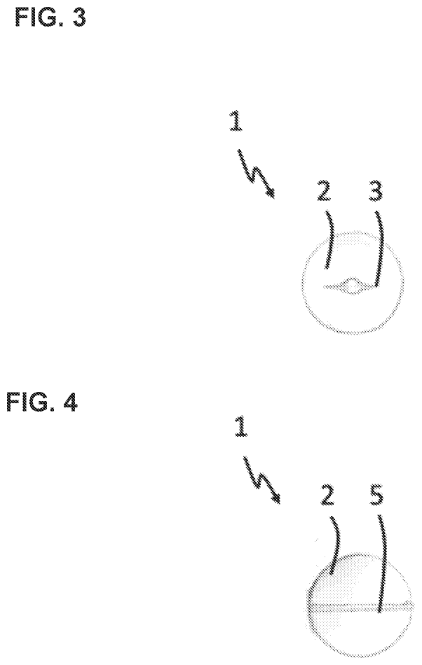

FIG. 1 illustrates a liquid specialty delivery device 1 assuming the form of a soft gelatin capsule.

The device 1 comprises a soft gelatin reservoir 2 and a cap 3 hermetically closing the reservoir 2.

The cap 3 is molded in one piece with the rest of the device. The cap 3 consists solely of gelatin and is preferably solid. It does not contain any liquid, so that the product is entirely housed in the reservoir 2, which guarantees better observance of the quantity to be ingested.

The reservoir 2 is hermetic and contains a predetermined quantity of product.

The reservoir 2 has a weakening line 4 connected to the cap 3.

The cap 3 and the part of the reservoir 2 having the weakening line 4 form a system for opening the reservoir 2, making it possible to release the product without the use of tools. When the cap is turned or pulled by the user, the weakening line 4 is weakened and tends to break. As a result, the user has access to the product without having been in contact or brought an object into contact with the product, thus limiting any risk of contamination.

A tab 5, also called tail, is added to the device 1, placed on the opposite side of the reservoir 2 relative to the cap 3.

The tab 5 is filled with soft gelatin.

The entire device 1 is molded in the same material—which facilitates its manufacture—and in one piece. Thus, there is no risk of perforation or leakage subsequent to molding.

The tab 5 allows the practitioner and the parents to hold the device when delivering the product.

The tab 5 offers the possibility of a grip so as not to exert pressure on the reservoir part 2 at the time of opening and thus to prevent the liquid from exiting before delivery.

The tab 5 may bear variable information 6, for example, the name of the molecule or its code and dosage. It allows differentiation of the products, because the dosage and the name of the product can be noted on it, thus limiting any risk of confusion.

The molecule can be chosen from the following group: paracetamol, ibuprofen, melatonin, loratadine, vitamins, vitamin K, loperamide, nefopam, morphine, acetazolamide, dexamethasone, methotrexate, aprepitant, spironolactone, sildenafil, caffeine, midazolam, ranitidine, ondansetron, prednisone, ivermectin, vitamin D.

The variable information 6 on the tab 5 can be molded during the filling process. Other inscription means can be considered such as printing, engraving or adding a label.

The tab 5 makes it possible to make the device larger and wider in order to prevent any risk of suffocation, if a child were to swallow it.

The tab 5 makes it possible to hold the device during delivery, allowing a better grip and thus preventing the risk for the child of swallowing it.

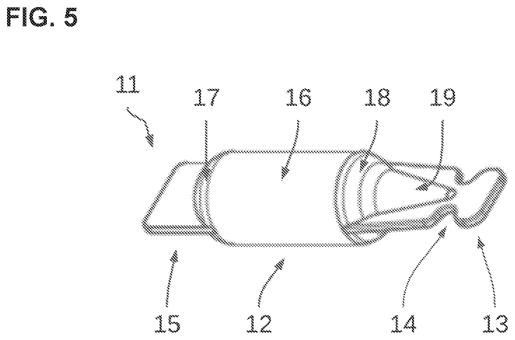

FIG. 5 illustrates a liquid specialty delivery device 11 assuming the form of a soft gelatin capsule.

As before, the device 11 comprises a soft gelatin reservoir 12 and a cap 13 hermetically closing the reservoir 2. The reservoir 12 has a weakening line 14 connected to the cap 13. A tab 15, also called tail, is added to the device 11, placed on the opposite side of the reservoir 12 with respect to the cap 3.

The reservoir 12 comprises a portion 16 of substantially cylindrical shape disposed between a half-sphere 17 closing on the tab 15 side and a partial half-sphere 18 closing on the weakening line 14 side.

The partial half-sphere is closed on the side of the weakening line 14 by a part 19, preferably of substantially conical shape. The part 19 could be cylindrical or flared. The substantially conical-shaped part 19 can also make it possible to hold and close the reservoir 12, using one hand, while the weakening line 14 is weakened and tends to break due to the forces exerted, for example, by another hand, on the cap 13. The pressure applied to the conical or flared part will prevent any leakage of liquid and will guarantee that the final dose to be administered remains inside the reservoir.

The disclosure also relates to a device as described above in which the reservoir contains, as a liquid specialty, a pharmaceutical composition comprising a molecule chosen from: paracetamol-acetaminophen, ibuprofen, melatonin, loratadine, vitamins, vitamin K, loperamide, nefopam, morphine, acetazolamide, dexamethasone, methotrexate, aprepitant, spironolactone, sildenafil, caffeine, midazolam, ranitidine, ondansetron, prednisone, ivermectin, vitamin D.

As will be readily understood, the disclosure is not limited to the examples that have just been described, and numerous modifications may be made to these examples without departing from the scope of the invention as defined by the claims. In addition, the various features, forms, variants, and embodiments of the disclosure can be grouped together in various combinations as long as they are not incompatible or mutually exclusive.

1. A device for the delivery of a liquid formulation comprising a pharmaceutical or food, the device comprising:
a soft gelatin reservoir;
a cap hermetically closing the reservoir; and
a tab arranged on an opposite side of the reservoir relative to the cap, the tab being filled with soft gelatin, wherein the tab has a cross-section less than or equal to a cross-section of the reservoir.

2. The device of claim 1, wherein the reservoir comprises a part having a substantially cylindrical shape closed on a side of the reservoir adjacent the tab, and closing on a side of the reservoir adjacent the cap by a part having a substantially conical shape.

3. The device of claim 2, wherein the device is molded from a single material.

4. The device of claim 3, wherein the is molded in one piece.

5. The device of claim 4, wherein the cap is filled with soft gelatin.

6. The device of claim 5, wherein the reservoir has a weakening line connecting the reservoir to the cap.

7. The device of claim 6, wherein the tab bears variable information.

8. The device of claim 7, wherein the reservoir contains, as a liquid formulation, a pharmaceutical composition comprising a molecule chosen from: paracetamol-acetaminophen, ibuprofen, melatonin, loratadine, vitamins, vitamin K, loperamide, nefopam, morphine, acetazolamide, dexamethasone, methotrexate, aprepitant, spironolactone, sildenafil, caffeine, midazolam, ranitidine, ondansetron, prednisone, ivermectin, vitamin D.

9. A method of delivering a liquid formulation to a person, comprising:
providing a liquid delivery device including:
a soft gelatin reservoir;
a cap hermetically closing the reservoir, the reservoir containing the liquid formulation, the liquid formulation comprising a pharmaceutical or food; and
a tab arranged on an opposite side of the reservoir relative to the cap, the tab being filled with soft gelatin, wherein the tab has a cross-section less than or equal to a cross-section of the reservoir; and
using the liquid delivery device to deliver the liquid formulation to a person, wherein the delivery device is held by a user by way of the tab of the device.

10. The device of claim 1, wherein the device is molded from a single material.

11. The device of claim 10, wherein the device is molded in one piece.

12. The device of claim 1, wherein the cap is filled with soft gelatin.

13. The device of claim 1, further comprising a weakening line between the reservoir and the cap.

14. The device of claim 1, wherein the tab bears variable information.

15. The device of claim 1, wherein the reservoir contains, as a liquid formulation, a pharmaceutical composition comprising a molecule chosen from: paracetamol-acetaminophen, ibuprofen, melatonin, loratadine, vitamins, vitamin K, loperamide, nefopam, morphine, acetazolamide, dexamethasone, methotrexate, aprepitant, spironolactone, sildenafil, caffeine, midazolam, ranitidine, ondansetron, prednisone, ivermectin, vitamin D.
